(19) United States
(12) Patent Application Publication
(10) Pub. No.: US 2003/0177964 A1
(43) Pub. Date: Sep. 25, 2003

(54) Fertilizer knife

(76) Inventor: Herb Stam, Watseka, IL (US)

Correspondence Address: Mark Manley, 5205 W 32nd, Sedalia, MO, 65301, US

(21) Appl. No.: 10/379,197

(22) Filed: Mar. 3, 2003

Related U.S. Application Data
(60) Provisional application No. 60/362,035, filed on Mar. 5, 2002.

(51) Int. Cl. A01C 23/00

(52) U.S. Cl. 111/123

(57) ABSTRACT

A fertilizer knife for use in applying anhydrous ammonia comprising a leading edge having a flat face. A projecting shoe attached to the leading edge that is flat to minimize packing of soil against furrow sidewalls. A fertilizer delivery tube disposed on a back edge of the knife having a bend portion adjacent the bottom surface of the projecting shoe leading to a fertilizer release hole under the bottom surface of the knife.

### BACKGROUND OF THE INVENTION

Fertilizer knives are used with agricultural implements known as ammonia applicators in the trade.

Fertilizer knives are attached to an implement and can be used during different times from prior to planting to post emergence. Applicant has supplied various knives to the trade that have become popular and been copied by many competitors. A good ammonia knife places the ammonia in the soil and seals it there with dirt.

U.S. Pat. No. 4,132,181 shows a common knife useful for placing ammonia. The knife has a cast point 3 to resist wear and a tube 8 that releases ammonia substantially below the level of the soil. The idea is that after the knife passes soil will fall back into the furrow created as the knife is pulled through the soil and thereby seal the ammonia underground instead of allowing it to escape into the air. Patent '181 characterizes several of the problems with prior art knives. First, the long curved front 3 tends to throw dirt in a wide path, this is undesirable at any time but cannot be tolerated once plants have emerged. After plant emergence, the thrown soil covers the small plants stunting or killing them. A second problem is that while the sharp point 2 seems like a good idea, use rapidly wears off the point and requires replacement. Another problem with this knife is the knife profile (FIG. 3), which is tapered from front to back. This tapered profile will pack soil against the sidewalls of the furrow as the knife passes through the soil. By packing the soil, the knife leaves an opening that much of the ammonia will escape from. The knife of patent '181 might trap ammonia effectively in some soils, but in damp or clay soil it will be ineffective and allow too much ammonia to escape causing unwanted pollution as well as an economic loss to the farmer.

As mentioned a knife like '181 has a very limited ground speed in a post emergence environment. A knife such as '181 is limited to much less than 2 miles per hour in post emergence corn for example. If the knife travels any faster than 2 miles per hour the soil thrown by the curve of the knife will do too much damage to the young plants. Knives such as '181 also have a problem of allowing ammonia to escape back out adjacent to the tube that delivers the ammonia. This occurs because as the knife has the furrow open, there is still an opening up and out into the atmosphere adjacent to the knife so as the ammonia is released into the furrow a portion can escape.

U.S. Pat. No. 5,452,673 shows an ammonia knife without the front curve. This straight up and down knife will throw less soil than the curved front knife. However, this knife has a profile that also tends to pack soil against the sidewalls of the furrow and will allow the ammonia to escape. Patent '673 attempts to correct that situation by dragging a cover device 40, known in the industry as a beaver tail, behind it. Many knives will drag something like a plate or chain to improve coverage of the ammonia, however these devices do not work well and can also throw more dirt. These devices drug through the soil also tend to wear rapidly and break off requiring replacement of the knife. The cover device 40 for example, can only cover right at the soil surface as shown, this is not where you want the ammonia which should be trapped several inches deep. Place the cover device 40 deeper and it will throw dirt, provide drag, require frequent replacement and still not cover totally because the knife is packing the soil against the side walls of the furrow as it creates the furrow.

As can be seen, there is a need for an improved ammonia knife and ammonia application method for farming and particularly for post emergence application, that are economical and effective to use.

### SUMMARY OF THE INVENTION

An improved ammonia knife particularly useful in side dressing applications post emergence. The knife is effective in creating a furrow without packing soil against the walls of the furrow such that ammonia placed by the knife can be sealed.

In another aspect of the knife the wear edges of the knife are flat to minimize wear damage to the knife and to reduce the tendency to pack soil against the sidewalls of the furrow.

In yet another aspect of the knife soil is lifted and ammonia is released under the knife to minimize the unwanted release of ammonia. The ammonia tube is bent to release ammonia under the knife, and the ammonia is released forward of where the furrow is closing to minimize leakage and effectively seal the ammonia.

These and other features, aspects and advantages of the present invention will become better understood with reference to the following drawings, description and claims.

### BRIEF DESCRIPTION OF THE DRAWINGS

FIG. 1 Shows a side view of the knife, partially exploded;

FIG. 2 Shows a view of the front edge of the knife in use and;

FIG. 3 Shows a view of the underneath of the knife.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

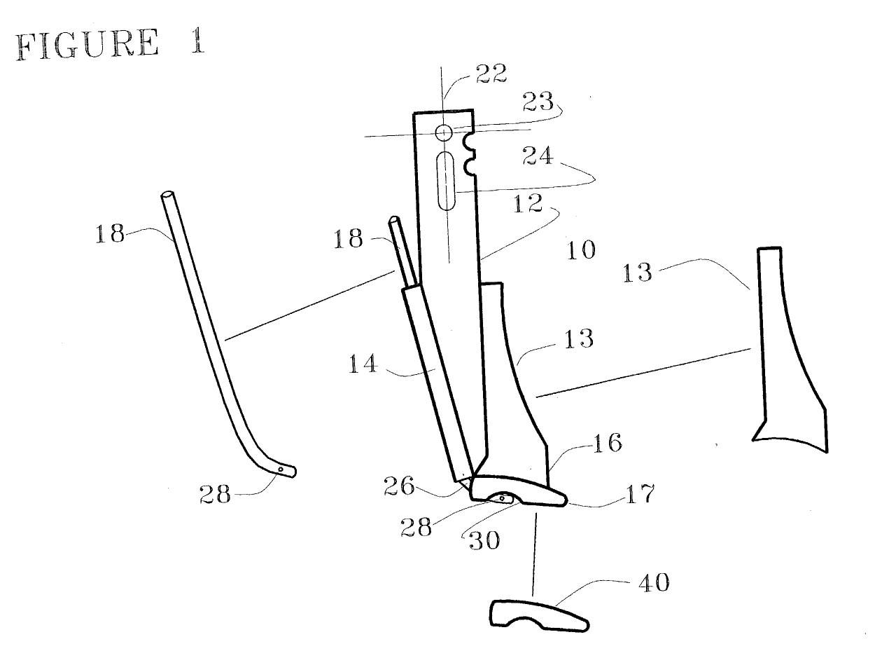

FIG. 1 illustrates a side view of the preferred embodiment of the present invention, a fertilizer knife 10 comprising a blank 12, a casting 13, tube protectors 14 and a fertilizer tube 18. The casting 13 includes a soil divider 16, a leading edge 17. The hole 23 and slot 24 in the blank 12 are used in mounting the knife 10 to an implement not shown. The fertilizer tube 18 includes a bend 26 near the bottom of casting 13 and the tube 18 includes a hole 28 passing through the tube 18 to allow anhydrous ammonia to flow from both sides of the tube 18 and from both sides of the knife 10. The knife 10 can be assembled from its component parts by welding as shown.

FIG. 1 illustrates that casting 13 allows the tube 18 to bend 26 and pass under the bottom of casting 13. Placing the ammonia outlet hole 28 under the knife 10 and casting 13 gives it optimum performance in terms of sealing ammonia. Cutout area 30 gives the ammonia the ability to disperse somewhat within the soil. Placing the tube 18, 26 within the cutout area 30 protects the tube 18, 26 from being crushed when the knife 10 carrying implement, not shown, is placed on a hard surface such as concrete when not in use. Placing the outlet hole 28 of the tube 18 under the shoe 40 prevents ammonia from traveling up adjacent to the tube 18 to escape from the soil. It is common in the prior art for a knife to have a straight ammonia tube and this can lead to ammonia, released under ground, traveling up near the straight tube where it is released into the air. A curved tube 18, 26 again leads to a greater amount of the ammonia applied staying underground where it can provide benefit. Releasing the ammonia sideways under the knife 10 makes it almost impossible for the ammonia to leak up adjacent the tube 18 prior to the furrow sealing with dirt.

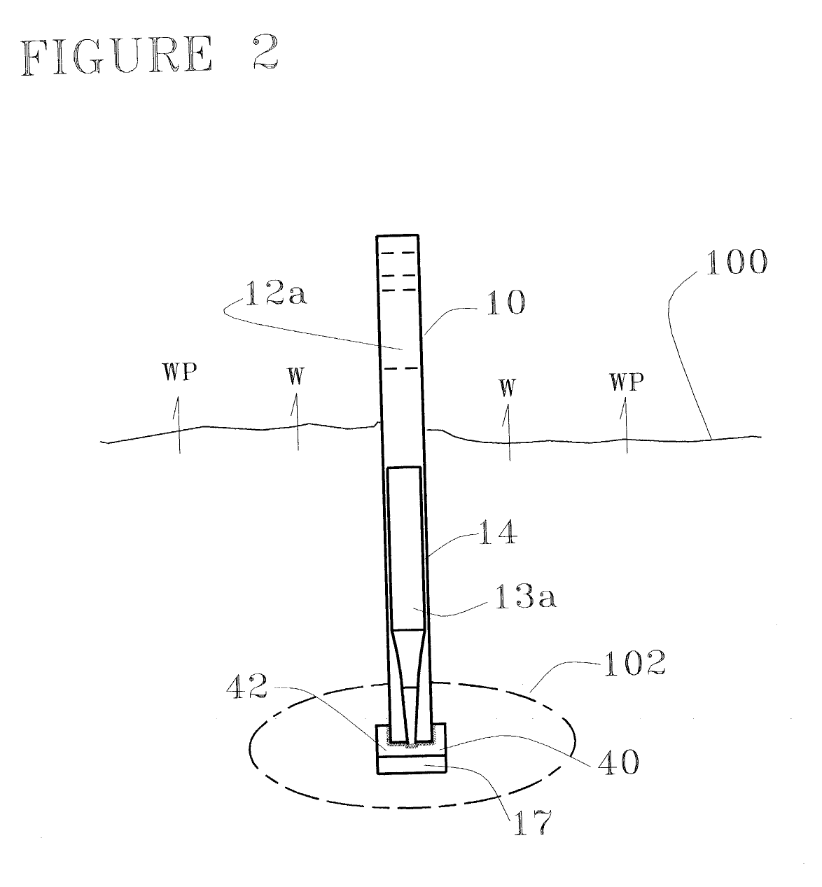

FIG. 2 illustrates the knife 10 in use in soil 100. The front edge 12a of the blank 12 is flat. This design is counter intuitive to most designers who will put a sharp edge on the leading edge of a knife. Experimentation has shown that a flat front edge 12a gives two major advantages. First it tends to push the soil and a small amount of soil will accumulate and pack on the flat 12a this protects the edge 12a from wear and greatly extends the life of the knife 10 with a minimum of increased drag. The second advantage of the flat leading edge 12a again comes from pushing dirt. A sharp leading edge tends to pack soil against the sidewalls of the furrow and allow anhydrous ammonia to escape from the furrow. The flat leading edge 12a pushes the dirt instead of packing it and this leads to a better seal of the dirt as the knife 10 passes. Soil tends to roll off a flat edge 12a as opposed to packing. A net effect of this is that a farmer can get into a field when it is wetter, often several days earlier then would otherwise be possible. The front edge of the casting 13 is also flat 13a. The flat 13a has the same advantages described for the flat 12a. As best shown in FIG. 1 these flat edges 12a and 13a are nearly perpendicular to the ground 100 when in use. The shoe 40 also has a flat leading edge 17. FIG. 2 also shows that the top surface 42 of shoe 40 is tilted to provide soil lift as the knife 10 travels through the soil. Since the ammonia is released under the shoe 40, the lift occurs, creating a tunnel, just as the ammonia is released.

In FIG. 2 lines w-w indicate the width to which soil will be thrown by this knife 10 compared to wp-wp which indicates a much greater width of soil thrown by prior art knives. The nearly vertical attack of the knife 10 shown in FIG. 1 leads to some of its ability to not disrupt topsoil. Also the shoe 40, which presents a very small profile 102 in the soil, minimizes soil disruption. The profile 102 indicates a cross section of a tunnel in the soil 100 created by the lift of shoe top surface 42. This mole like hole profile 102 is where almost all the ammonia applied will be trapped.

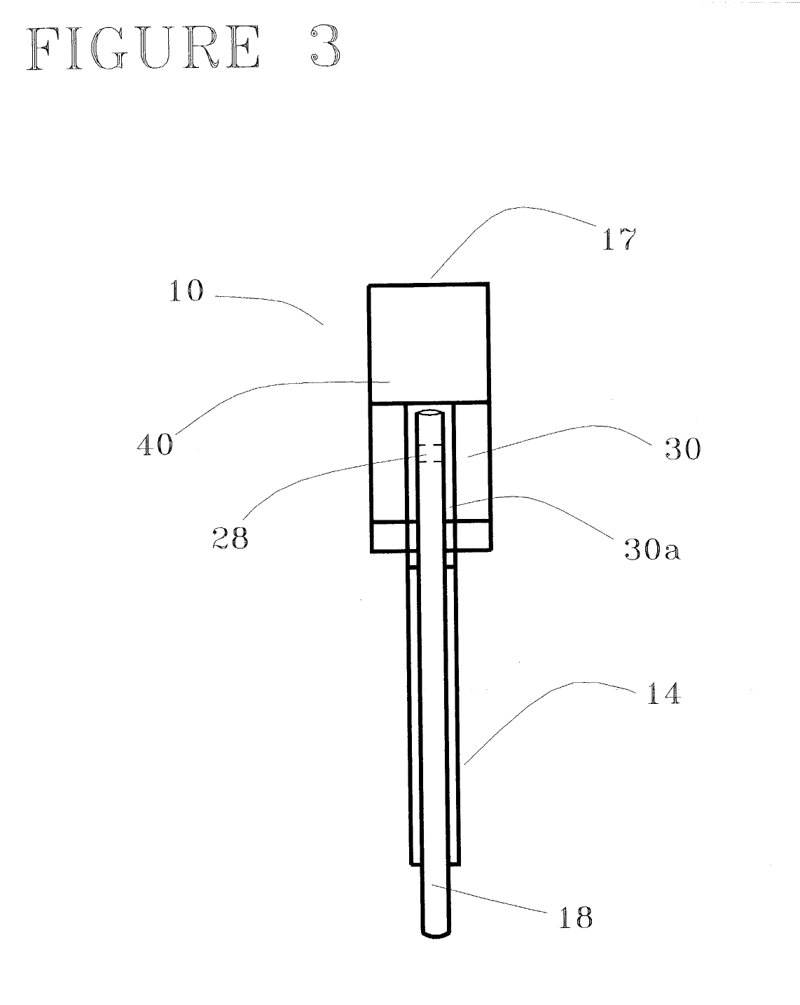

FIG. 3 shows the bottom of the knife 10. The shoe 40 portion of the casting 13 includes the opening 30 shown in FIG. 1. It also includes a cylindrical opening 30a to accommodate the tube 18 as it passes from bend 26 under the knife 10.

In use, as shown in FIG. 2 the knife 10 throws a minimum of soil on top the ground 100. The lines w-w indicate how far the present knife 10 would throw dirt compared to a prior art knife throw wp-wp traveling at the same speed. For side dressing corn, for example, a prior art knife would be limited to about 2.5 miles per hour. If a tractor pulling the prior art knife traveled faster it would throw dirt far enough, wp in FIG. 2, to cover corn seedlings not shown. In a similar application of side dressing corn an implement pulling the knife 10 can travel up to 6 miles per hour without hurting seedlings. The benefit to the farmer then is a knife 10 that allows the farmer to complete an operation in less than half the time and with superior sealing of the ammonia underground.

It should be understood, of course, that the foregoing relates to preferred embodiments of the invention and that modifications may be made without departing from the spirit and scope of the invention as set forth in the following claims.

We claim:

1. A fertilizer knife for use in applying anhydrous ammonia comprising;
an attachment point;
a leading edge of said knife, said leading edge having a flat face;
a projecting shoe attached to said leading edge, said shoe having a top surface and a bottom surface;
a fertilizer delivery tube disposed on a back edge of said knife and said tube having a bend portion adjacent the bottom surface of said projecting shoe and said bend portion leading to a fertilizer release hole midway under said bottom surface of said shoe.

2. The fertilizer knife of claim 1 wherein the bottom surface of said shoe includes a cavity, and wherein said release hole is contained in said cavity.

3. The fertilizer knife of claim 2 wherein the tube end is closed and wherein the release hole is in the sidewall of said tube.

4. The fertilizer knife of claim 1 wherein the top surface of said shoe provides a soil lift surface.

5. The fertilizer knife of claim 1 wherein a portion of said bottom surface of said shoe extends lower than said release hole to prevent crushing of said tube.

6. A fertilizer knife for use in applying anhydrous ammonia comprising;
an attachment point;
a leading edge of said knife, said leading edge having a flat face;
a projecting shoe attached to said leading edge, said shoe having a top surface and a bottom surface;
a fertilizer delivery tube disposed on a back edge of said knife and said tube having a fertilizer release hole midway under said bottom surface of said shoe, wherein the bottom surface of said shoe includes a cavity, and wherein said release hole is contained in said cavity.

7. The fertilizer knife of claim 6 wherein the cavity includes an opening to the back of the knife to accommodate said tube and wherein the cavity includes side release openings to allow ammonia to escape sideways from under the knife.

8. The fertilizer knife of claim 7 wherein the top surface includes a tilted planar surface to provide soil lift over said release hole.

9. The fertilizer knife of claim 7 wherein a portion of said bottom surface of said shoe extends lower than said release hole to prevent crushing of said tube.

10. A fertilizer knife for use in applying anhydrous ammonia comprising;
an attachment point;
a leading edge of said knife,
a projecting shoe attached to said leading edge, said shoe having a top surface and a bottom surface;
a fertilizer delivery tube disposed on a back edge of said knife and said tube having a fertilizer release hole under said bottom surface of said shoe, wherein the top surface of said shoe includes a tilted planar surface to provide soil lift over said release hole.

11. The fertilizer knife of claim 10 wherein a cavity on the bottom of said shoe includes an opening to the back of the knife to accommodate said tube and wherein the cavity includes side release openings to allow ammonia to escape perpendicular to said tube from under the knife.

12. The fertilizer knife of claim 10 wherein the bottom surface of said shoe includes a cavity, and wherein said release hole is contained in said cavity.
